(19) United States
(12) Patent Application Publication
(10) Pub. No.: US 2025/0258463 A1
(43) Pub. Date: Aug. 14, 2025

(54) Band Identification for a Wearable Computing Device

(71) Applicant: Google LLC, Mountain View, CA (US)

(72) Inventors: Yuan-Jen Chang, Taipei (TW); Shih-Hsien Yang, Taipei (TW)

(21) Appl. No.: 19/111,113

(22) PCT Filed: Sep. 1, 2022
(86) PCT No.: PCT/US2022/042332

§ 371 Date: Mar. 12, 2025

(51) Int. Cl. G04G 19/00; G04G 21/02

(52) U.S. Cl. CPC G04G 19/00; G04G 21/025

(57) ABSTRACT

A wearable computing device includes a housing, an energy storage device and a power interface configured to deliver electrical power from the energy storage device to a circuit included on a band that is removably coupled to the housing. The wearable computing device includes a switching device configured to selectively couple the energy storage device to the power interface. The wearable computing device includes a processor configured to control operation of the switching device to couple the energy storage device to the power interface to deliver the electrical power to the circuit included on that band. The processor is configured to obtain data from the circuit on the band that is indicative of a unique identifier for the band. The processor is configured to control operation of the wearable computing device based. at least in part. on the data indicative of the unique identifier for the band.

### FIELD

The present disclosure relates generally to wearable computing devices. More particularly, the present disclosure relates to identifying a band that is used to fasten a wearable computing device to a user's appendage (e.g., wrist).

### BACKGROUND

Wearable computing devices can be fastened to the user's wrist via a band that can be removably coupled to a housing of the wearable computing device. In this manner, the band can be an accessory to wearable computing devices. For example, a first band that is coupled to the housing of a wearable computing device can be decoupled from the housing and a second band that is different (e.g., color, material, etc.) than the first band can be coupled to the housing.

### SUMMARY

Aspects and advantages of embodiments of the present disclosure will be set forth in part in the following description, or can be learned from the description, or can be learned through practice of the embodiments.

In one aspect, a wearable computing device is provided. The wearable computing device includes a housing, an energy storage device and a power interface. The power interface is configured to deliver electrical power from the energy storage device to a circuit included on a band that is removably coupled to the housing. The wearable computing device further includes a switching device configured to selectively couple the energy storage device to the power interface. The wearable computing device further includes a processor configured to control operation of the switching device to couple the energy storage device to the power interface to deliver the electrical power to the circuit included on that band. The processor is further configured to obtain data from the circuit on the band. The data is indicative of a unique identifier for the band. The processor is further configured to control operation of the wearable computing device based, at least in part, on the data indicative of the unique identifier for the band.

In some embodiments, the power interface includes a first conductor for power and a second conductor for electrical ground.

In some embodiments, the processor is configured to obtain the data indicative of the unique identifier for the band via the first conductor of the power interface.

In some embodiments, the wearable computing device further includes one or more sensors and the processor is further configured to determine whether the wearable computing device is being worn by a user based, at least in part, on the data from the one or more sensors. In some embodiments, the one or more sensors include a heart rate sensor and the data obtained from the one or more sensors includes heart rate data.

In some embodiments, the processor is configured to control operation of the switching device to couple the energy storage device to the power interface in response to determining the wearable computing device is not being worn by the user based, at least in part, on the data obtained from the one or more sensors.

In some embodiments, the processor is further configured to control operation of the switching device to decouple the energy storage device from the power interface in response to obtaining the data indicative of the unique identifier for the band.

In some embodiments, the unique identifier identifies one or more features of the band. In some embodiments, the one or more features of the band include at least one of a material of the band or a color of the band.

In some embodiments, the unique identifier is indicative of the band including one or more sensors. In such embodiments, the processor is configured to obtain data from the one or more sensors on the band. Furthermore, in some embodiments, the processor is configured to obtain the data from the one or more sensors via the power interface.

In another aspect, a method for identifying a band coupled to a housing of a wearable computing device is provided. The method includes determining, via a processor of the wearable computing device, the wearable computing device is not being worn by a user. In response to determining the wearable computing device is not being worn by the user, the method further includes controlling, via the processor of the wearable computing device, a switching device of the wearable computing device to electrically couple an energy storage device of the wearable computing device to a power interface of the wearable computing device to transfer electrical power from the energy storage device to a circuit included on the band coupled to the housing of the wearable computing device. The method further includes obtaining, via the processor, data indicative of a unique identifier for the band from the circuit on the band. The method further includes controlling, via the processor, operation of the wearable computing device based, at least in part, on the unique identifier for the band.

In some embodiments, the operation of determining the wearable computing device is not being worn by the user includes obtaining data from one or more sensors of the wearable computing device and determining the band is coupled to the housing of the wearable computing device based, at least in part, on the data from the one or more sensors.

In some embodiments, controlling operation of the wearable computing device includes controlling, via the processor, operation of an electronic output device of the wearable computing device. In some embodiments, the electronic output device includes a display screen, the unique identifier indicates a color of the band, and controlling operation of the display screen includes adjusting a color of at least a portion of the display screen based, at least in part, on the color of the band.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a wearable computing device worn on an extremity of a user according to some implementations of the present disclosure.

FIG. 2 depicts a perspective view of the wearable computing device of FIG. 1 according to some implementations of the present disclosure.

FIG. 3 depicts a block diagram of components of a system for identifying a band removably coupled to a housing of a wearable computing device according to some embodiments of the present disclosure.

FIG. 4 depicts a power interface of a system for identifying a band removably coupled to a housing of a wearable computing device according to some embodiments of the present disclosure.

FIG. 5 depicts a system for identifying a band removably coupled to a housing of a wearable computing device according to some embodiments of the present disclosure.

FIG. 6 depicts a system for identifying a band removably coupled to a housing of a wearable computing device according to some embodiments of the present disclosure.

FIG. 7A depicts a voltage signal at the processor on the band in FIG. 6 as a function of time according to an embodiment of the present disclosure.

FIG. 7B depicts a binary signal output by the processor on the band in FIG. 5 as a function of time according to an embodiment of the present disclosure.

FIG. 8 depicts a system for identifying a band removably coupled to a housing of a wearable computing device according to some embodiments of the present disclosure.

FIG. 9A depicts a circuit on a band according to an embodiment of the present disclosure.

FIG. 9B depicts a circuit on a band according to an embodiment of the present disclosure.

FIG. 9C depicts a circuit on a band according to an embodiment of the present disclosure.

FIG. 9D depicts a circuit on a band according to an embodiment of the present disclosure.

FIG. 9E depicts a circuit on a band according to an embodiment of the present disclosure.

FIG. 10 depicts a flow diagram of a method for identifying a band removably coupled to a wearable computing device according to an embodiment of the present disclosure.

FIG. 11 depicts another flow diagram of a method for identifying a band removably coupled to a wearable computing device according to an embodiment of the present disclosure.

FIG. 12 depicts yet another flow diagram of a method for identifying a band removably coupled to a wearable computing device according to an embodiment of the present disclosure.

FIG. 13 depicts components of a computing system for a wearable computing device according to an embodiment of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to a system for identifying which of a plurality of different bands (e.g., wrist bands) is currently removably coupled to a housing of a wearable computing device. The system can include a first circuit that is part of the wearable computing device and a second circuit that is part of each the plurality of different bands. The system can further include a power interface configured to deliver electrical power from an energy storage device (e.g., battery, capacitor) of the wearable computing device to the second circuit of one of the bands. The second circuit can communicate to the first circuit a unique identifier for the band. The first circuit can then identify the band based, at least in part, on the unique identifier.

The wearable computing device can be uniquely operated according to the identity of the band that is removably coupled to the housing of the wearable computing device. For instance, an electronic output device of the wearable computing device can be uniquely operated based, at least in part, on the identity of the band. In some embodiments, the electronic output device can include a display screen and a color of at least a portion of the display screen can be changed based on the identity of the band that is removably coupled to the housing of the wearable computing device. For example, in some embodiments, the color of the background of the display screen can be changed to match the color of the band. In such embodiments, it should be understood that the color of the band can be determined based, at least in part, on the unique identifier for the band.

In some embodiments the band can include one or more sensors (e.g. biometric sensors) that are not present on the wearable computing device. In such embodiments, the unique identifier can indicate the band includes the one or more sensors. Furthermore, in such embodiments, the wearable computing device can be operated to obtain data via the one or more sensors that are present on the band.

In some embodiments, the first circuit can be configured to identify the band when the user is not wearing the wearing the wearable computing device. For instance, the first circuit can obtain data from one or more sensors (e.g., heart rate sensors, motion sensors, etc.) that is indicative of whether the user is wearing the wearable computing device. In this manner, the first circuit can obtain the unique identifier for the band while the wearable computing device is not being worn (e.g., off-wrist) by the user.

The disclosed technology can provide numerous technical effects and benefits. For instance, the wearable computing device according to the present disclosure can identify different bands being used by the user to secure the wearable computing device to the user's appendage (e.g., wrist). Furthermore, the wearable computing device can be uniquely operated based, at least in part, on the identity of the band that is removably coupled to the housing of the wearable computing device. More particularly, the wearable computing device can perform functions that are specific to the type of band that is currently attached to the housing of the wearable computing device, which can improve the user experience.

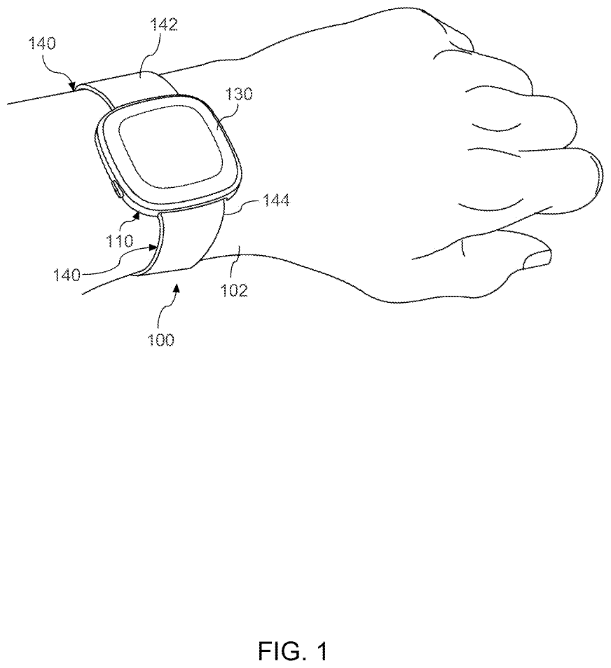

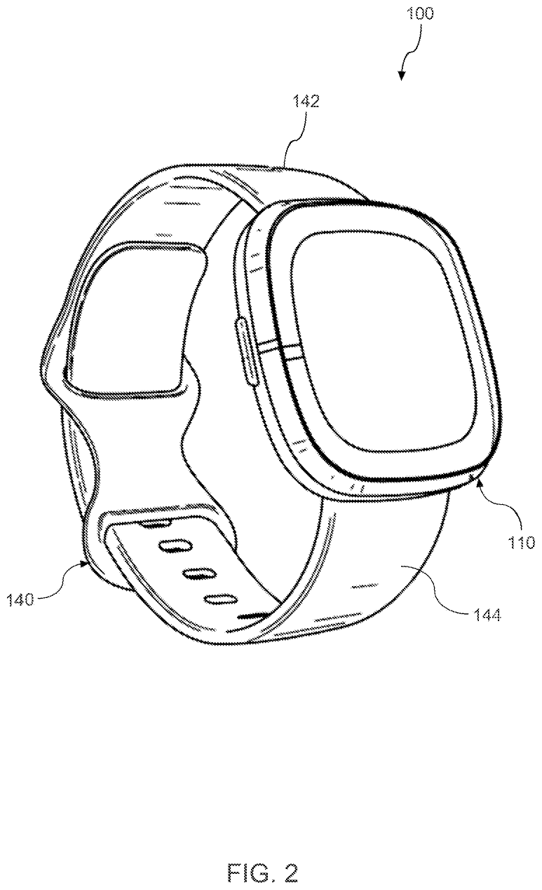

Referring now to the FIGS., FIGS. 1 and 2 depict a wearable computing device 100 according to an embodiment of the present disclosure. As shown, the wearable computing device 100 can be worn, for instance, on an arm 102 (e.g., wrist) of a user. The wearable computing device 100 can include a housing 110 defining a cavity in which one or more electronic components (e.g., disposed on printed circuit boards) are disposed. For instance, the wearable computing device 100 can include a printed circuit board 120 (e.g., flexible printed circuit board) disposed within the cavity. Furthermore, one or more electronic components can be included on the printed circuit board 120. The wearable computing device 100 can further include a battery (not shown) that is disposed within the cavity defined by the housing 110.

In some embodiments, the wearable computing device 100 includes a display 130. The display 130 can display content (e.g., date, time, step count, heart rate, etc. etc.) for viewing by the user. It should be understood that the display 130 can include any suitable type of display. For instance, in some embodiments, the display 130 can be an organic light emitting diode (OLED) display. It should be understood that the display 130 can be positioned underneath a display cover. In this manner, the display 130 can be protected from being damaged (e.g., scratched, cracked). It should also be understood that the display cover can be transparent. In this manner, the user can view the display 130 through the display cover.

As shown, the wearable computing device 100 can be secured to the arm 102 (e.g., wrist) of the user via a band 140. The band 140 can include a first portion 142 and a second portion 144 that is separate from the first portion 142. The first portion 142 of the band 140 can be removably coupled to the housing 110 at a first location thereon. Conversely, the second portion 144 of the band 140 can be removably coupled to the housing 110 at a second location thereon that is different than the first location. For instance, the first location and the second location can be on opposing sides of the housing 110.

It should be understood that the first portion 142 of the band 140 can be coupled to the second portion 144 of the band 140 to fasten the wearable computing device 100 to the arm 102 of the user. In some embodiments, the first portion 142 of the band 140 can include a buckle or clasp (not shown). Additionally, the second portion 144 of the band 140) can include a plurality of apertures (not shown) spaced apart from one another along a length of the second portion 144 of the band 140. In such embodiments, a prong of the buckle associated with the first portion 142 of the band 140 can extend through one of the plurality of openings defined by the second portion 144 of the band 140 to couple the first portion 142 of the band 140 to the second portion 144 of the band 140.

It should be appreciated that the first portion 142 of the band 140 can be coupled to the second portion 144 of the band 140 using any suitable type of fastener. For instance, in some embodiments, the first portion 142 of the band 140 and the second portion 144 of the band 140 can include a magnet. In such embodiments, the first portion 142 of the band 140 and the second portion 144 of the band 140 can be magnetically coupled to one another to fasten the wearable computing device 100 to the arm 102 of the user. It should also be appreciated that the band 140 can be swapped out for different bands. For instance, the band 140 can be of a first type (e.g., color, material) and can be swapped out for a band of a second type that is different than the first type. In this manner, the band 140 can be an accessory to the wearable computing device 100 that can be customized according to the user's preferences.

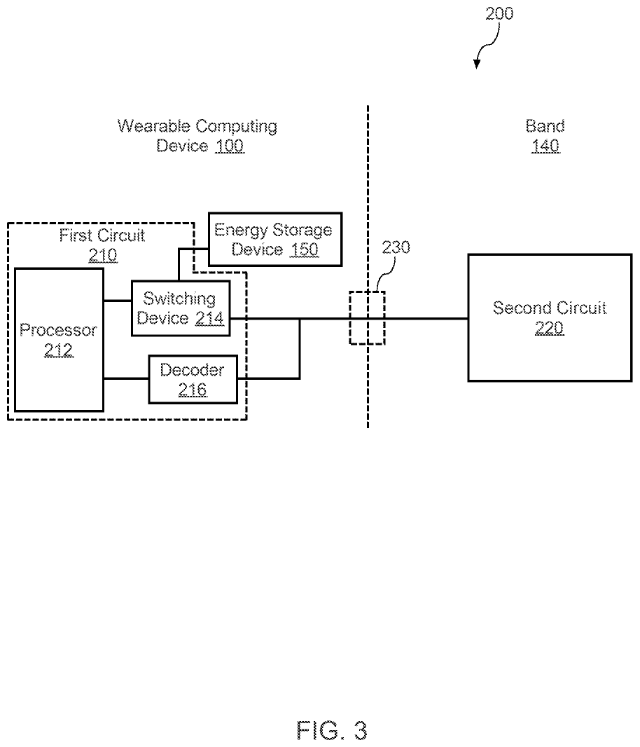

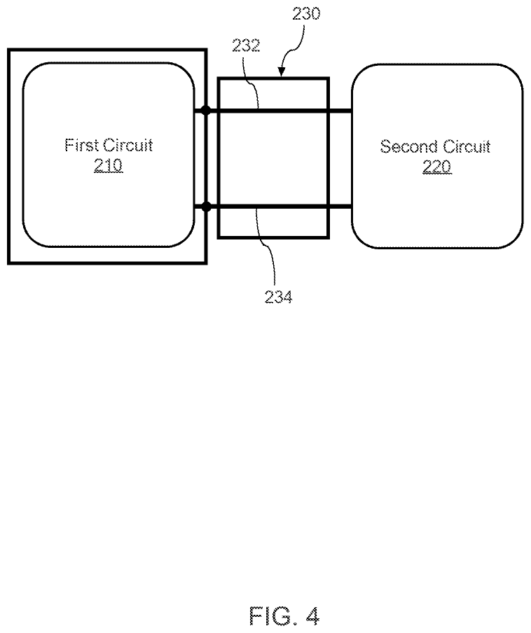

Referring now to FIGS. 3 and 4, a system 200 for identifying the band 140 coupled to the housing 110 (FIG. 1) of the wearable computing device 100 is provided according to an embodiment of the present disclosure. As shown, the system 200 can be distributed across both the wearable computing device 100 and the band 140. More particularly, the system 200 can include a first circuit 210 that is onboard (e.g., part of) the wearable computing device 100 and a second circuit 220 that is onboard (e.g., part of) the band 140. In some embodiments, the second circuit 220 can be included on the first portion 142 (FIG. 2) of the band 140 or the second portion 144 (FIG. 2) of the band 140. In alternative embodiments, the second circuit 220 can be included on both the first portion 142 of the band 140 and the second portion 144 of the band 140. For instance, in some embodiments, a first instance of the second circuit 220 can be included on the first portion 142 of the band 140) and a second instance of the second circuit 220 can be included on the second portion 144 of the band 140.

The system 200 can include a power interface 230 configured to deliver electrical power from an energy storage device 150 (e.g., battery, capacitor, etc.) on the wearable computing device 100 to the second circuit 220 included on the band 140. In some embodiments, the power interface 230 can include a first conductor 232 (e.g., wire) for delivering power from the energy storage device 150 (FIG. 3) of the wearable computing device 100 to the second circuit 220 included on the band 140. The power interface 230 can further include a second conductor 234 that is electrically grounded. It should be understood that the power interface 230 can be implemented on both the wearable computing device 100 and the band 140 as electrical contacts. For instance, the first conductor 232 of the power interface 230) can be implemented as a first electrical contact on the wearable computing device 100 and the band 140. Additionally, the second conductor 234 can be implemented as a second electrical contact on the wearable computing device 100 and the band 140. It should be understood that the electrical contacts on the band 140 contact the respective contacts on the wearable computing device 100 when the band 140 is removably coupled to the housing 110 (FIG. 2) of the wearable computing device 100.

In some embodiments, the first circuit 210 can include a processor 212 and a switching device 214. The switching device 214 can be electrically coupled between the energy storage device 150 and the power interface 230. Furthermore, the processor 212 can be communicatively coupled to the switching device 214. In this manner, the processor 212 can communicate one or more control signals associated with controlling operation of the switching device 214. For instance, the processor 212 can control operation of the switching device 214 to couple the energy storage device 150 to power interface 230 so that electrical power can be transferred from the energy storage device 150 to the second circuit 220 included on the band 140. Conversely, the processor 212 can control operation of the switching device 214 to decouple the energy storage device 150 from the power interface 230 so that electrical power cannot be transferred from the energy storage device 150 to the second circuit 220 included on the band 140.

In some embodiments, the processor 212 can control operation of the switching device 214 based, at least in part, on data obtained from one or more sensors of the wearable computing device 100. For instance, in some embodiments, the processor 212 can control operation of the switching device 214 to couple the energy storage device 150 to the power interface 230 in response to determining the wearable computing device 100 is being worn by the user. In this manner, electrical power can be transferred from the energy storage device 150 to the second circuit 220 included on the band 140 when the wearable computing device 100 is being worn by the user.

In some embodiments, the processor 212 can control operation of the switching device 214 to couple the energy storage device 150 to the power interface in response to determining the wearable computing device 100 is not being worn by the user. In this manner, electrical power can be transferred from the energy storage device 150 to the second circuit 220 included on the band 140 when the wearable computing device 100 is not being worn by the user.

It should be understood, however, that any suitable sensor that is configured to obtain data indicative of whether the user is wearing the wearable computing device 100 is within the scope of the present disclosure. For instance, in some embodiments, the one or more sensors can include a motion sensor (e.g., accelerometer, inertial measurement unit, etc.). In alternative embodiments, the one or more sensors can include a heart rate sensor.

The second circuit 220 can be configured to communicate a unique identifier (e.g., code, address, etc.) for the band 140 to the first circuit 210. The unique identifier can indicate one or more characteristics of the band 140. For example, the unique identifier can indicate the color of the band 140. Alternatively, or additionally, the unique identifier can indicate the material of the band 140. For instance, the unique identifier can indicate whether the material of the band 140 is waterproof. In some embodiments, the unique identifier can indicate the band 140 includes one or more sensors (e.g., motion sensors, touch sensors, etc.). For instance, in some embodiments, the band 140 can include sensors that are not included on the wearable computing device 100. In such embodiments, the band 140 can be attached to the housing 110 of the wearable computing device 100 to provide additional functionality (e.g., sensing capability).

In some embodiments, the second circuit 220 can be configured to modulate the unique identifier onto a signal to generate a modulated signal that is communicated to the wearable computing device 100. For instance, in some embodiments, the second circuit 220) can communicate the modulated signal to the first circuit 210 via the power interface 230. In alternative embodiments, the second circuit 220 can communicate the modulated signal to the first circuit 210 via a wireless network. It should be understood that the second circuit 220 can be configured to implement any suitable modulation scheme. For instance, in some embodiments, the second circuit 220 can be configured to modulate the unique identifier onto the signal according to an on-off keying modulation scheme.

In some embodiments, the first circuit 210 can include a decoder 216 configured to decode the modulated signal received from the second circuit 220. For instance, the decoder 216 can decode the modulated signal to obtain the unique identifier for the band 140. Furthermore, the decoder 216 can communicate the unique identifier to the processor 212.

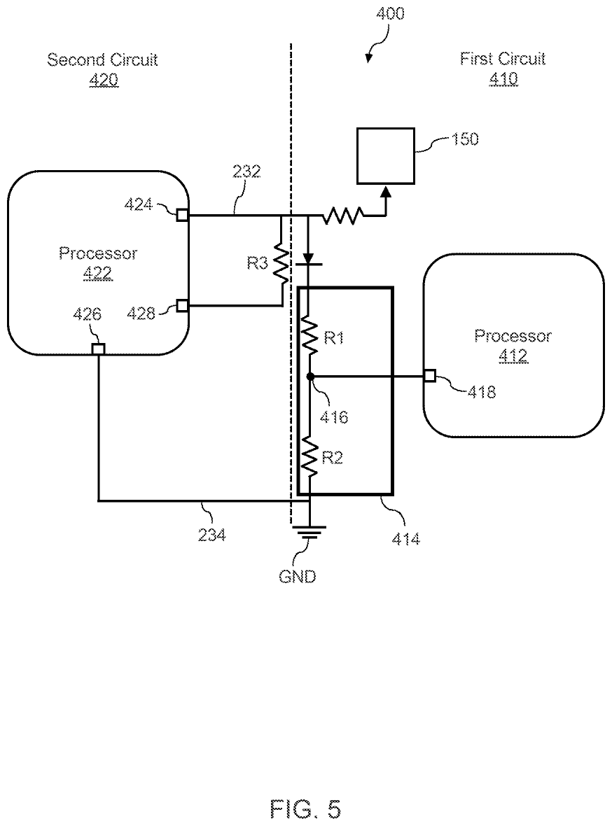

Referring now to FIG. 5, a system 400 for identifying the band 140 is provided according to an embodiment of the present disclosure. As shown, the system 400 can be distributed across both the wearable computing device 100 and the band 140. For instance, the system 400 can include a first circuit 410 that is part of the wearable computing device 100 and a second circuit 420 that is part of the band 140. Furthermore, the system 400 can include the power interface 230 discussed above with reference to FIGS. 3 and 4.

The first circuit 410 on the wearable computing device 100 can include a processor 412. The first circuit 410 can further include a voltage divider circuit 414 electrically coupled between the first conductor 232 (e.g., power) of the power interface 230 (FIG. 4) and the second conductor 234 (e.g., ground) of the power interface 230. The voltage divider circuit 414 can include a first resistor R1 having a first resistance and a second resistor R2 having a second resistance R2 that is different (e.g., larger, smaller) than the first resistance of the first resistor R1.

The voltage divider circuit 414 can be configured to step down a voltage across the first conductor 232 and the second conductor 234 from a first voltage (e.g., about 5 Volts) to a second voltage. The second voltage can include a range of voltages (e.g., about 0.5 Volts to about 2 Volts). Furthermore, the processor 412 can be electrically coupled to the voltage divider circuit 414 at a node 416 that is positioned between the first resistor R1 and the second resistor R2. In some embodiments, the processor 412 can include a general purpose input output (GPIO) pin that is electrically coupled to the node 416. In this manner, the processor 412 can be configured to read the GPIO pin 418 to obtain the output (e.g., stepped down second voltage) of the voltage divider circuit 414.

In some embodiments, the second circuit 420 on the band 140 can include a processor 422. As shown, the processor 422 can be electrically coupled to the first conductor 232 of the power interface 230 (FIG. 4). For instance, the processor 422 can include a voltage supply pin 424 that is electrically coupled to the first conductor 232 of the power interface 230. The processor 422 can further include a ground pin 426 that is electrically coupled to the second conductor 234 of the power interface 230.

The processor 422 can further include a general purpose input output (GPIO) pin 428 that is electrically coupled to the first conductor 232 of the power interface 230 (FIG. 4). As shown, the second circuit 420 can include a resistor R3 electrically coupled between the first conductor 232 and the GPIO pin 428. In some embodiments, a resistance of the resistor R3 can be different than the resistance of the first and second resistors R1, R2 of the voltage divider circuit 414.

In some embodiments, the processor 422 can be configured to control the GPIO pin 428 to communicate the unique identifier for the band 140. For instance, the processor 422 can drive the GPIO pin 428 low for a first instance of time such that a voltage drop between the first conductor 232 and the second conductor 234 corresponds to a first voltage. Furthermore, the processor 422 can drive the GPIO pin 428 high such that a voltage drop between the first conductor 232 and the second conductor 234 corresponds to a second voltage that is different (e.g., greater) than the first voltage. It should be understood that the processor 422 can drive the GPIO pin 428 low or high by writing a first value (e.g., zero) or a second value (e.g., a one), respectively, to the GPIO pin 428. For instance, in some embodiments, the processor 422 can write the first value to GPIO pin 428 to drive the GPIO pin low. Conversely, the processor 422 can write the second value to the GPIO pin 428 to drive the GPIO pin 428 high.

In some embodiments, the processor 412 of the first circuit 410 can be configured to read the GPIO pin 418 while the processor 422 of the second circuit 420 is driving the GPIO pin 428 thereof to communicate the unique identifier for the band 140. In this manner, the processor 412 can obtain a plurality of voltage measurements for the output of the voltage divider circuit 414.

The processor 412 can be configured to assign a binary value (e.g., a 1 or a 0) to each of the plurality of voltage measurements for the output of the voltage divider circuit 414. For instance, the processor 412 can be configured to assign a first binary value (e.g., a 1) when the output of the voltage divider circuit 414 is equal to or greater than a threshold voltage and a second binary value (e.g., a 0) when the output of the voltage divider circuit 414 is less than the threshold voltage. In this manner, the plurality of voltage measurements for the output of the voltage divider circuit 414 can be converted into a digital signal from which the processor 412 can determine the identity of the band 140.

Although the system 400 is discussed with reference to the second circuit 420 on the band 140 (FIG. 3) communicating data (e.g., the unique identifier) to the first circuit 410 on the wearable computing device 100 (FIG. 3), it should be understood that the system 400 is not intended to be limited in this manner. For instance, in some embodiments, the system 400 can be configured to allow bidirectional data communications between the first circuit 410 and the second circuit 420 through the power interface 230 (FIG. 4).

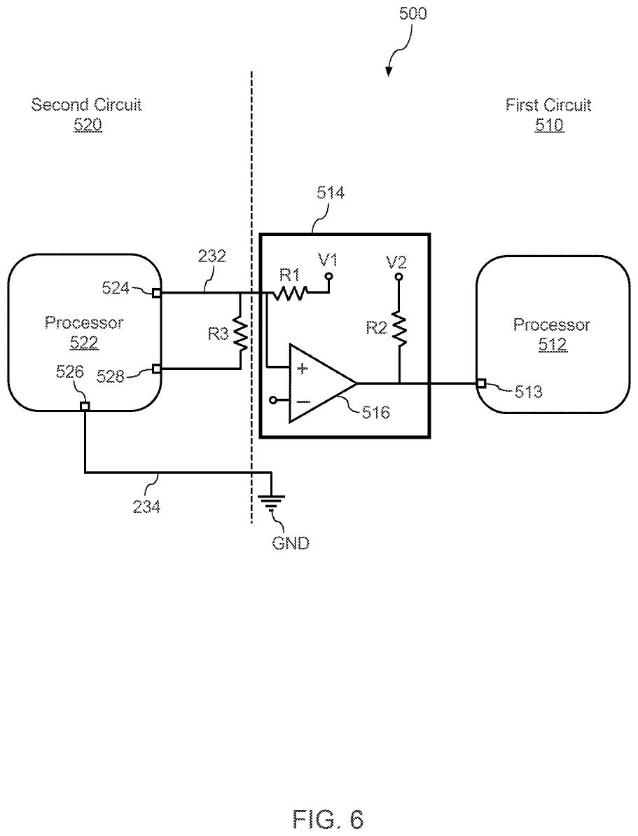

Referring now to FIG. 6, a system 500 for identifying the band 140 is provided according to an embodiment of the present disclosure. As shown, the system 500 can be distributed across both the wearable computing device 100 and the band 140. For instance, the system 500 can include a first circuit 510 that is part of the wearable computing device 100 and a second circuit 520 that is part of the band 140. Furthermore, the system 500 can include the power interface 230 discussed above with reference to FIGS. 3 and 4.

The first circuit 510 can include a processor 512 and a comparator circuit 514. As shown, the comparator circuit 514 can be electrically coupled between the first conductor 232 of the power interface 230 (FIG. 4) and the second conductor 234 of the power interface 230. The comparator circuit 514 can include a first resistor R1 to hold the first conductor 232 at a first potential V1 (e.g., about 3 Volts). The comparator circuit 514 can include an operational amplifier 516. As shown, a first input (e.g., non-inverting input) of the operational amplifier 516 can be electrically coupled to the first conductor 232 of the power interface 230. Furthermore, a second input (e.g., inverting input) of the operational amplifier 516 can be electrically coupled to a general purpose input output (GPIO) pin 513. As shown, the comparator circuit 514 can include a second resistor R2 to hold the GPIO pin 513 at a second potential V2 that is less than the first potential V1.

In some embodiments, the second circuit 520 on the band 140 can include a processor 522. As shown, the processor 522 can be electrically coupled to the first conductor 232 of the power interface 230 (FIG. 4). For instance, the processor 522 can include a voltage supply pin 524 that is electrically coupled to the first conductor 232 of the power interface 230. The processor 522 can further include a ground pin 526 that is electrically coupled to the second conductor 234 of the power interface 230).

The processor 522 can further include a general purpose input output (GPIO) pin 528 that is electrically coupled to the first conductor 232 of the power interface 230 (FIG. 4). As shown, the second circuit 520 can include a resistor R3 electrically coupled between the first conductor 232 and the GPIO pin 528. In some embodiments, a resistance of the resistor R3 can be different than the resistance of the first and second resistors R1, R2 of the comparator circuit 514.

In some embodiments, the processor 522 can be configured to control the GPIO pin 528 to communicate the unique identifier for the band 140. For instance, the processor 522 can drive the GPIO pin 528 low for a first instance of time such that the first potential V1 corresponds to a first voltage. Furthermore, the processor 522 can drive the GPIO pin 528 high such that the first potential V1 corresponds to a second voltage that is different (e.g., greater) than the first voltage. It should be understood that the processor 522 can drive the GPIO pin 528 low or high by writing a first value (e.g., zero) or a second value (e.g., a one), respectively, to the GPIO pin 528. For instance, in some embodiments, the processor 522 can write the first value to GPIO pin 528 to drive the GPIO pin low. Conversely, the processor 522 can write the second value to the GPIO pin 528 to drive the GPIO pin 528 high.

It should be understood that the operational amplifier 516 can compare the first potential V1 to the second potential V2 (e.g., reference potential). It should also be understood that the operational amplifier 516 can output a first value when the first potential V1 is greater than the second potential V2 and a second value when the first potential V2 is not greater than the second potential V2. It should also be understood that the processor 512 can determine the unique identifier for the band 140 based on changes in the output of the operational amplifier 516 when the processor 522 on the band is driving the GPIO pin 528 thereof to communicate the unique identifier.

Although the system 500 is discussed with reference to the second circuit 520 on the band 140 (FIG. 3) communicating data (e.g., the unique identifier) to the first circuit 510 on the wearable computing device 100 (FIG. 3), it should be understood that the system 500 is not intended to be limited in this manner. For instance, in some embodiments, the system 500 can be configured to allow bidirectional data communications between the first circuit 510 and the second circuit 520 through the power interface 230 (FIG. 4).

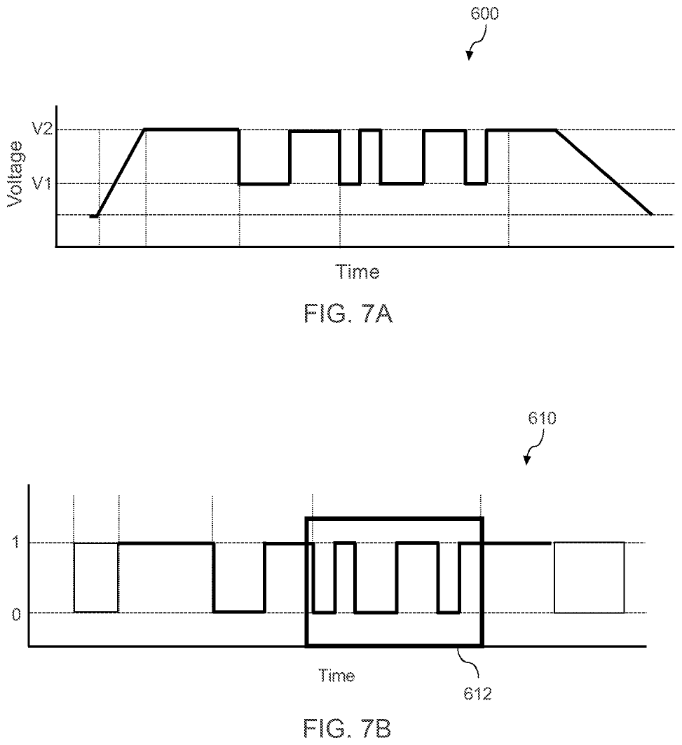

Referring now to FIGS. 7A and 7B, two separate voltage signals are provided as a function of time according to embodiments of the present disclosure. FIG. 7A depicts a voltage signal 600 measured at the voltage supply pin 524 (FIG. 6) of the processor 522 (FIG. 6) of the second circuit 520 (FIG. 6) over a period of time. Additionally, FIG. 7B depicts a binary signal 610 measured at the GPIO pin 528 (FIG. 6) of the processor 522 (FIG. 6) of the second circuit 520 (FIG. 6) over the same period of time. It should be understood that the portion of the binary signal 610 denoted by box 612 indicates the unique identifier for the band 140 (FIG. 2). For instance, the GPIO pin 528 can be driven low or high to communicate the unique identifier for the band 140. It should be understood that driving the GPIO pin 528 low or high causes the voltage signal 600 to switch between a first voltage V1 and a second voltage V2, respectively.

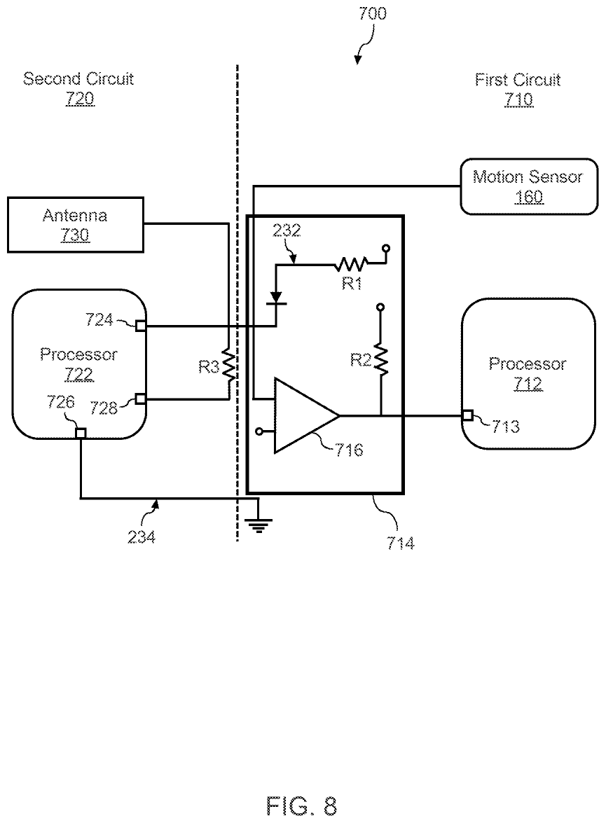

Referring now to FIG. 8, a system 700 for identifying the band 140 is provided according to an embodiment of the present disclosure. As shown, the system 700 can be distributed across both the wearable computing device 100 and the band 140. For instance, the system 700 can include a first circuit 710 that is part of the wearable computing device 100 and a second circuit 720 that is part of the band 140. Furthermore, the system 700 can include the power interface 230 discussed above with reference to FIGS. 3 and 4.

The first circuit 710 can include a processor 712 and a comparator circuit 714. As shown, the comparator circuit 714 can be electrically coupled between the first conductor 232 of the power interface 230 (FIG. 4) and the second conductor 234 of the power interface 230. The comparator circuit 714 can include a first resistor R1 to hold the first conductor 232 at a first potential V1 (e.g., about 3 Volts). The comparator circuit 714 can include an operational amplifier 716. As shown, a first input (e.g., non-inverting input) of the operational amplifier 716 can be electrically coupled to the first conductor 232 of the power interface 230. Furthermore, a second input (e.g., inverting input) of the operational amplifier 516 can be electrically coupled to a general purpose input output (GPIO) pin 713. As shown, the comparator circuit 714 can include a second resistor R2 to hold the GPIO pin 713 at a second potential V2 that is less than the first potential V1.

In some embodiments, the second circuit 720 on the band 140 can include a processor 722. As shown, the processor 722 can be electrically coupled to the first conductor 232 of the power interface 230) (FIG. 4). For instance, the processor 722 can include a voltage supply pin 724 that is electrically coupled to the first conductor 232 of the power interface 230 (FIG. 4). The processor 722 can further include a ground pin 726 that is electrically coupled to the second conductor 234 of the power interface 230.

The processor 722 can further include a general purpose input output (GPIO) pin 728 that is electrically coupled to the first conductor 232 of the power interface 230 (FIG. 4). As shown, the second circuit 720 can include a resistor R3 electrically coupled between the first conductor 232 and the GPIO pin 728. In some embodiments, a resistance of the resistor R3 can be different than the resistance of the first and second resistors R1, R2 of the comparator circuit 714.

In some embodiments, the processor 722 of the second circuit 720 can be configured to control the GPIO pin 728 to communicate the unique identifier for the band 140. For instance, the processor 722 can drive the GPIO pin 728 low for a first instance of time such that the first potential V1 corresponds to a first voltage. Furthermore, the processor 722 can drive the GPIO pin 728 high such that the first potential V1 corresponds to a second voltage that is different (e.g., greater) than the first voltage. It should be understood that the processor 722 can drive the GPIO pin 728 low or high by writing a first value (e.g., zero) or a second value (e.g., a one), respectively, to the GPIO pin 728. For instance, in some embodiments, the processor 722 can write the first value to GPIO pin 728 to drive the GPIO pin low. Conversely, the processor 722 can write the second value to the GPIO pin 728 to drive the GPIO pin 728 high.

It should be understood that the operational amplifier 716 can compare the first potential V1 to the second potential V2 (e.g., reference potential). It should also be understood that the operational amplifier 716 can output a first value when the first potential V1 is greater than the second potential V2 and a second value when the first potential V2 is not greater than the second potential V2. It should also be understood that the processor 712 can determine the unique identifier for the band 140 based on changes in the output of the operational amplifier 716 when the processor 722 on the band is driving the GPIO pin 728 thereof to communicate the unique identifier for the band 140).

As shown, the wearable computing device 100 (FIG. 1) can include a motion sensor 160 that is electrically coupled to the first conductor 232 of the power interface 230 (FIG. 4). The motion sensor 160 can be configured to obtain motion data indicative of movement of the wearable computing device 100. In this manner, the first circuit 710, specifically the processor 712 thereof, can determine whether the user is wearing the wearable computing device 100 based, at least in part, on the motion data obtained via the motion sensor 160. In some embodiments, the motion sensor can include an inertial measurement unit (IMU) sensor. It should be understood, however, that the motion sensor 160 can include any suitable type of sensor configured to detect motion. For instance, in some embodiments, the motion sensor 160 can include an accelerometer.

In some embodiments, the second circuit 720 on the band 140 can include an antenna 730. As shown, the antenna 730 can be electrically coupled to the processor 722 of the second circuit. For instance, the antenna 730) can be electrically coupled to the voltage supply pin 724 of the processor 722. In some embodiments, the antenna 730 can be configured to communicate the unique identifier for the band 140 to the wearable computing device 100 via a wireless network. Alternatively, or additionally, the band 140 can include one or more sensors (e.g., capacitive sensors) and the antenna 730 can be configured to communicate data from the one or more sensors to the wearable computing device 100. It should be understood that the wearable computing device 100 can include one or more antennas (not shown) to facilitate communication with the band 140 over the wireless network.

In some embodiments, the antenna 730) can also function as an electrode to sense a touch event (e.g., capacitive sensor) or user movement (e.g., static change variation sensing). Furthermore, in some embodiments, the antenna 730) can be communicatively coupled to the first circuit 710 on the wearable computing device 100. In this manner, data indicative of motion/touch events sensed by the antenna 730 when functioning as an electrode can be communicated to the processor 712 of the first circuit 710 on the wearable computing device 100. The first circuit 710 can be configured to process the data indicative of motion and/or touch events sensed by the antenna 730. For instance, in some embodiments, the processor 712 of the first circuit 710 can be configured to implement a machine-learning model to classify the data sensed by the antenna 730 as one of a plurality of different motion/touch events. In alternative embodiments, the machine-learning model can be implemented by the motion sensor 160 of the wearable computing device 100 to classify the data sensed by the antenna 730 as one of the plurality of different motion/touch events.

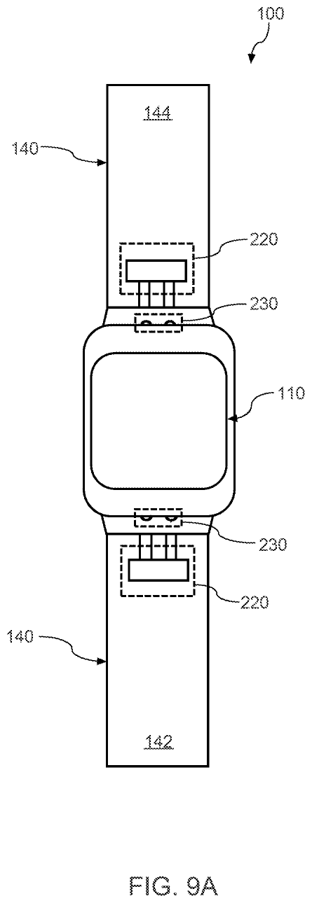

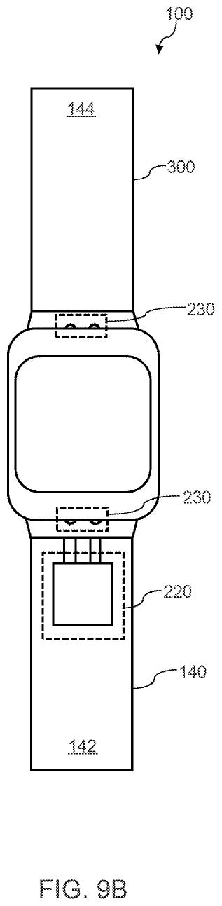

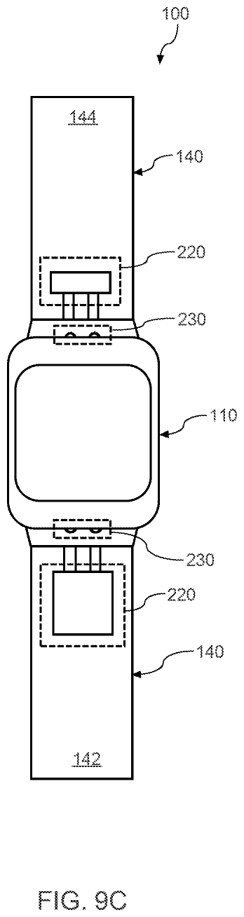

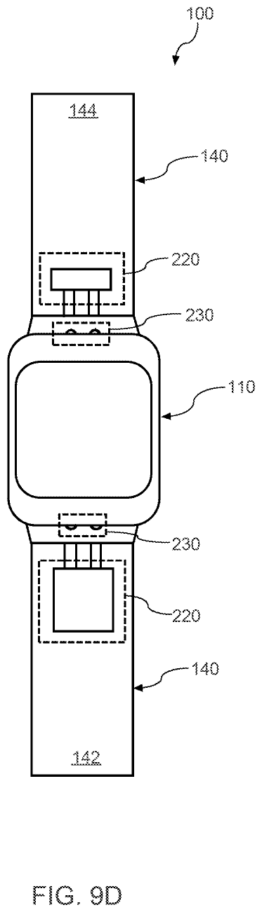

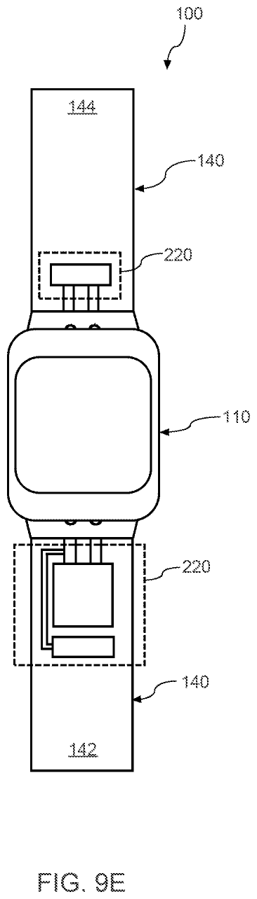

Referring now to FIG. 9A, an embodiment of the second circuit 220 on the band 140 is provided according to the present disclosure. As shown, the second circuit 220 can be included on the first portion 142 of the band 140 and the second portion 144 of the band 140. In some embodiments, the second circuit 220 can include a resistor. For instance, in some embodiments, the second circuit 220 on the first portion 142 of the band 140 can include a resistor. It should be understood that the resistors can have a resistance value that is unique to the band 140. In this manner, a voltage at the power interface 230 when the band 140 is coupled to the housing 110 of the wearable computing device 100 can uniquely identify the band 140.

Referring now to FIG. 9B, another embodiment of the second circuit 220 on the band 140 is provided according to the present disclosure. The second circuit 220 can include a logic circuit included on the first portion 142 of the band 140. The logic circuit can be configured to communicate the unique identifier for the band 140. In some embodiments, the second circuit 220 can be configured as the second circuit 420, 520 depicted in FIGS. 5 and 6.

Referring now to FIG. 9C, yet another embodiment of the second circuit 220 on the band 140 is provided according to the present disclosure. In some embodiments, the second circuit 220 disposed on the first portion 142 of the band 140 can be a logic circuit configured to communicate a unique identifier for the first portion 142 of the band 140. Additionally, the second circuit 220 disposed on the second portion 144 of the band 140 can be a resistor having a resistance value that can uniquely identify the second portion 144 of the band 140. For instance, the resistor can cause the voltage at the power interface 230 to have a voltage value that uniquely identifies the second portion 144 of the band 140.

Referring now to FIG. 9D, still another embodiment of the second circuit 220 on the band 140 is provided according to the present disclosure. In some embodiments, the second circuit 220 disposed on the first portion 142 of the band 140 can be a logic circuit configured to communicate a unique identifier for the band 140. Furthermore, the second circuit 220 disposed on the second portion 144 of the band 140 can include one or more sensors (e.g., capacitive sensors) configured to determine whether the band 140 is being worn by the user.

Referring now to FIG. 9E, another embodiment of the second circuit 220 on the band 140 is provided according to the present disclosure. In some embodiments, the second circuit 220) disposed on the first portion 142 of the band 140 can include a logic circuit configured to communicate a unique identifier for the band 140. In addition, the second circuit 220 disposed on the first portion 142 of the band 140 can further include one or more sensors configured to determine whether the band 140 is being worn by the user. Furthermore, in some embodiments, the second circuit 220 disposed on the second portion 144 of the band 140) can include one or more sensors configured to determine whether the band 140 is being worn by the user. In some embodiments, the one or more sensors on the second portion 144 of the band 140) can be different from the one or more sensors on the first portion 142 of the band 140).

It should be understood that the functionality of the band 140 depicted in FIGS. 9A-9E is not intended to be limited to having a circuit (e.g., second circuit 220) that stores and communicates a unique identifier for the band 140 to the wearable computing device 100. For instance, in some embodiments, the band 140) can include one or more motion sensors (e.g., accelerometer) configured to detect motion of the band 140. Alternatively, or additionally, the one or more sensors included on the band 140 can include one or more touch sensors. In such embodiments, data from the one or more motion sensors, the one or more touch sensors, or both can be processed (e.g., via a machine-learning model) to determine whether the data is indicative of the user performing one or more movements (e.g., predefined gestures). In some embodiments, the wearable computing device 100 can perform one or more control actions in response to determining the data corresponds to a predefined gesture.

In some embodiments, the band 140 can include an output device. For instance, in some embodiments, the output device can include an LED indicator. In such embodiments, the LED indicator can be activated (e.g., turned on) when the band 140 is attached to the wearable computing device 100 and receiving electrical power from the energy storage device 150 (FIG. 2) of the wearable computing device 100. In this manner, the LED indicator can provide a visual notification to the user that the band 140 is attached to the wearable computing device 100 and is receiving electrical power from the energy storage device 150 of the wearable computing device 100.

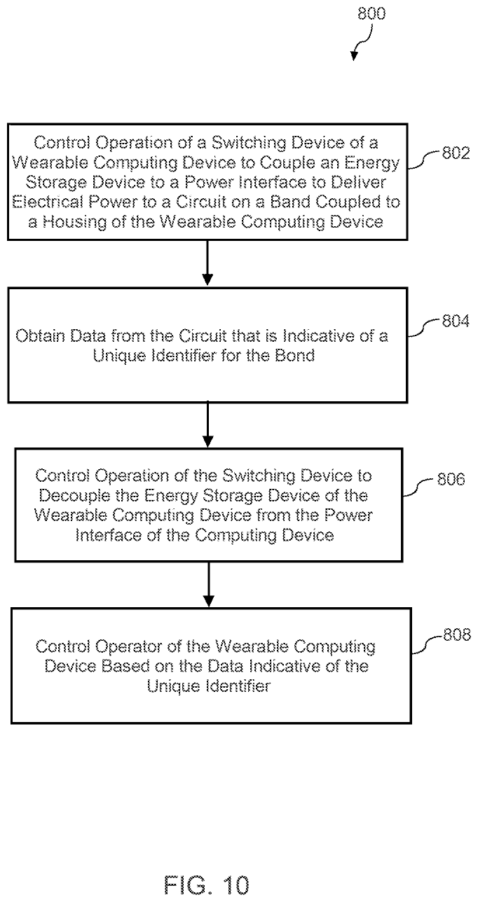

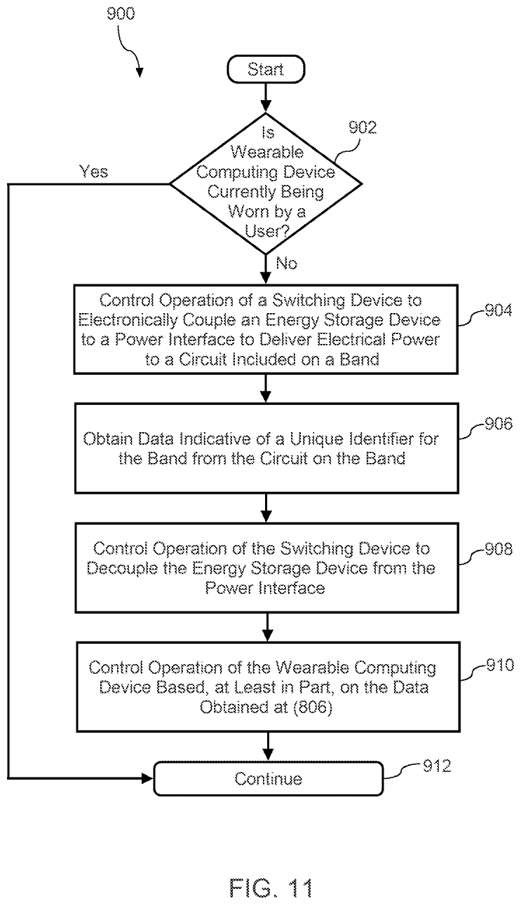

Referring now to FIG. 10, a flow diagram of an example method 800 for identifying a band for a wearable computing device is provided according to an embodiment of the present disclosure. The method 800 can be implemented by, for instance, any of the systems 200, 400, 500, 700 discussed above with reference to FIGS. 3, 5, 6, and 8. FIG. 10 depicts steps performed in a particular order for purposes of illustration and discussion. Those of ordinary skill in the art, using the disclosures provided herein, will understand that various steps of the method 800 or any of the other methods disclosed herein may be adapted, modified, rearranged, performed simultaneously, or modified in various ways without deviating from the scope of the present disclosure.

At (802), the method 800 can include controlling operation of a switching device to electrically couple an energy storage device of the wearable computing device to a power interface of the wearable computing device. In this manner, electrical power can be transferred from the energy storage device to a circuit included on the band that is removably coupled to the housing of the wearable computing device.

At (804), the method 800 can include obtaining data (e.g., unique identifier) from the circuit included on the band. In some embodiments, the circuit on the band can communicate the data to the wearable computing device via the power interface. More particularly, the circuit on the band can communicate the data via a power conductor of the power interface. In alternative embodiments, the circuit on the band can communicate the data over a wireless network to the wearable computing device. After obtaining the data, the method 800 can proceed to (808).

At (806), the method 800 can include controlling operation of the switching device to decouple the energy storage device of the wearable computing device from the power interface of the wearable computing device. In this manner, electrical power can no longer be transferred from the energy storage device to the circuit included on the band that is removably coupled to the housing of the wearable computing device.

At (808), the method 800 can include controlling operation of the wearable computing device based, at least in part, on the data obtained from the circuit on the band. For instance, in some embodiments, an electronic output device of the wearable computing device can be uniquely operated based, at least in part, on the data obtained at (804). In some embodiments, the electronic output device can include a display screen and a color of at least a portion of the display screen can be changed based on the identity of the band that is removably coupled to the housing of the wearable computing device. For example, in some embodiments, the color of the background of the display screen can be changed to match the color of the band. In such embodiments, it should be understood that the color of the band can be determined based, at least in part, on the unique identifier for the band.

Referring now to FIG. 11, a flow diagram of an example method 900 for identifying a band for a wearable computing device is provided according to an embodiment of the present disclosure. The method 900 can be implemented by, for instance, any of the systems 200, 400, 500, 700 discussed above with reference to FIGS. 3, 5, 6, and 8. FIG. 11 depicts steps performed in a particular order for purposes of illustration and discussion. Those of ordinary skill in the art, using the disclosures provided herein, will understand that various steps of the method 900 or any of the other methods disclosed herein may be adapted, modified, rearranged, performed simultaneously, or modified in various ways without deviating from the scope of the present disclosure.

At (902), the method 900 can include determining whether a wearable computing device is being worn by a user. In some embodiments, a first circuit on the wearable computing device can obtain data from one or more sensors configured to obtain data (e.g., motion data, heart rate data, etc.) indicative of whether the wearable computing device is being worn by the user. When the first circuit determines, based on the data from the one or more sensors, the wearable computing device is not being worn by the person, the method 900 proceeds to (904). Otherwise, the method 900 continues to (912).

At (904), the method 900 can include controlling operation of a switching device to electrically couple an energy storage device of the wearable computing device to a power interface of the wearable computing device. In this manner, electrical power can be transferred from the energy storage device to a circuit included on the band that is removably coupled to the housing of the wearable computing device.

At (906), the method 900 can include obtaining data (e.g., unique identifier) from the circuit included on the band. In some embodiments, the circuit on the band can communicate the data to the wearable computing device via the power interface. More particularly, the circuit on the band can communicate the data via a power conductor of the power interface. In alternative embodiments, the circuit on the band can communicate the data over a wireless network to the wearable computing device. After obtaining the data, the method 900 can proceed to (908).

At (908), the method 900 can include controlling operation of the switching device to decouple the energy storage device of the wearable computing device from the power interface of the wearable computing device. In this manner, electrical power can no longer be transferred from the energy storage device to the circuit included on the band that is removably coupled to the housing of the wearable computing device.

At (910), the method 900 can include controlling operation of the wearable computing device based, at least in part, on the data obtained from the circuit on the band. For instance, in some embodiments, an electronic output device of the wearable computing device can be uniquely operated based, at least in part, on the data obtained at (906). In some embodiments, the electronic output device can include a display screen and a color of at least a portion of the display screen can be changed based on the identity of the band that is removably coupled to the housing of the wearable computing device. For example, in some embodiments, the color of the background of the display screen can be changed to match the color of the band. In such embodiments, it should be understood that the color of the band can be determined based, at least in part, on the unique identifier for the band.

In some embodiments the band can include one or more sensors (e.g. biometric sensors) that are not present on the wearable computing device. In such embodiments, the unique identifier can indicate the band includes the one or more sensors. Furthermore, in such embodiments, the wearable computing device can be operated to obtain data via the one or more sensors that are present on the band. In this manner, the wearable computing device can provide additional functionality due, at least in part, to the presence of the one or more sensors on the band.

At (912), the method 900 can continue. For instance, in some embodiments, the method 900 can end. In alternative embodiments, the method 900 can remain at (902) and continue to obtain data from the one or more sensors of the wearable computing device until the data obtained from same indicates that the wearable computing device is not being worn by the user and the method can proceed to (904).

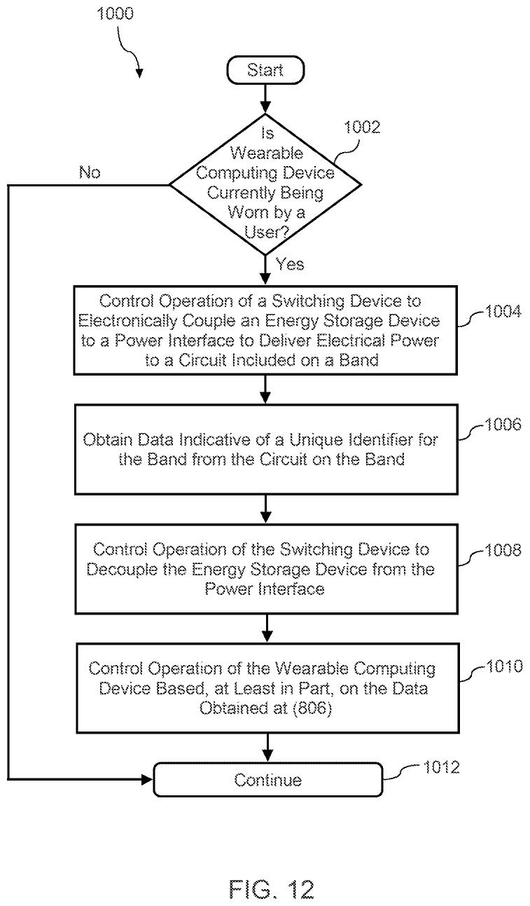

Referring now to FIG. 12, a flow diagram of an example method 1000 for identifying a band for a wearable computing device is provided according to an embodiment of the present disclosure. The method 1000 can be implemented by, for instance, any of the systems 200, 400, 500, 700 discussed above with reference to FIGS. 3, 5, 6, and 8. FIG. 12 depicts steps performed in a particular order for purposes of illustration and discussion. Those of ordinary skill in the art, using the disclosures provided herein, will understand that various steps of the method 1000 or any of the other methods disclosed herein may be adapted, modified, rearranged, performed simultaneously, or modified in various ways without deviating from the scope of the present disclosure.

At (1002), the method 1000 can include determining whether a wearable computing device is being worn by a user. In some embodiments, a first circuit on the wearable computing device can obtain data from one or more sensors configured to obtain data (e.g., motion data, heart rate data, etc.) indicative of whether the wearable computing device is being worn by the user. When the first circuit determines, based on the data from the one or more sensors, the wearable computing device is being worn by the person, the method 1000 proceeds to (1004). Otherwise, the method 1000 continues to (1012).

At (1004), the method 1000 can include controlling operation of a switching device to electrically couple an energy storage device of the wearable computing device to a power interface of the wearable computing device. In this manner, electrical power can be transferred from the energy storage device to a circuit included on the band that is removably coupled to the housing of the wearable computing device.

At (1006), the method 1000 can include obtaining data (e.g., unique identifier) from the circuit included on the band. In some embodiments, the circuit on the band can communicate the data to the wearable computing device via the power interface. More particularly, the circuit on the band can communicate the data via a power conductor of the power interface. In alternative embodiments, the circuit on the band can communicate the data over a wireless network to the wearable computing device. After obtaining the data, the method 1000 can proceed to (1008).

At (1008), the method 1000 can include controlling operation of the switching device to decouple the energy storage device of the wearable computing device from the power interface of the wearable computing device. In this manner, electrical power can no longer be transferred from the energy storage device to the circuit included on the band that is removably coupled to the housing of the wearable computing device.

At (1010), the method 1000 can include controlling operation of the wearable computing device based, at least in part, on the data obtained from the circuit on the band. For instance, in some embodiments, an electronic output device of the wearable computing device can be uniquely operated based, at least in part, on the data obtained at (1006). In some embodiments, the electronic output device can include a display screen and a color of at least a portion of the display screen can be changed based on the identity of the band that is removably coupled to the housing of the wearable computing device. For example, in some embodiments, the color of the background of the display screen can be changed to match the color of the band. In such embodiments, it should be understood that the color of the band can be determined based, at least in part, on the unique identifier for the band.

In some embodiments the band can include one or more sensors (e.g. biometric sensors) that are not present on the wearable computing device. In such embodiments, the unique identifier can indicate the band includes the one or more sensors. Furthermore, in such embodiments, the wearable computing device can be operated to obtain data via the one or more sensors that are present on the band. In this manner, the wearable computing device can provide additional functionality due, at least in part, to the presence of the one or more sensors on the band.

At (1012), the method 1000 can continue. For instance, in some embodiments, the method 800 can end. Alternatively, the method 1000 can remain at (1002) and continue to obtain data from the one or more sensors of the wearable computing device until the data obtained from same indicates that the wearable computing device is not being worn by the user and the method can proceed to (1004).

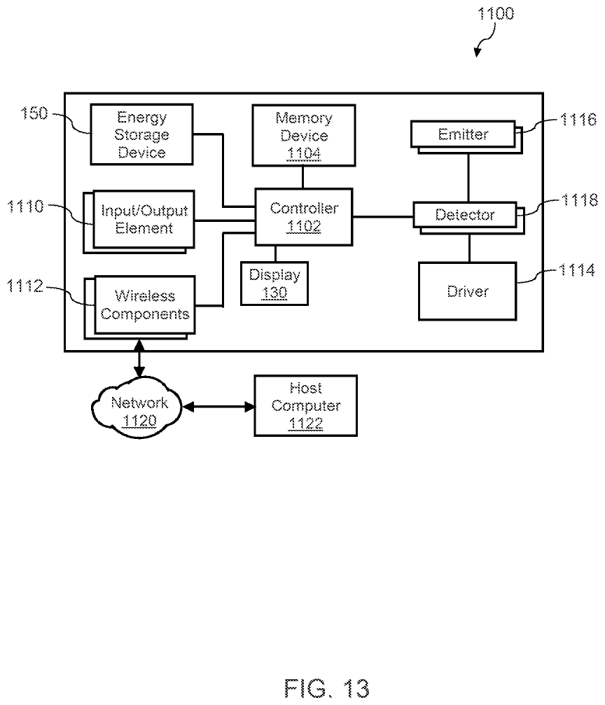

Referring now to FIG. 13, components of an example computing system 1100 of the wearable computing device 100 that can be utilized in accordance with various embodiments are illustrated. In particular, as shown, the computing system 1100 may also include at least one controller 1102. Moreover, in an embodiment, the controller(s) 1102 can be a central processing unit (CPU) or graphics processing unit (GPU) for executing instructions that can be stored in a memory device 1104, such as flash memory or DRAM, among other such options. For example, in an embodiment, the memory device 1104 may include RAM, ROM, FLASH memory, or other non-transitory digital data storage, and may include a control program comprising sequences of instructions which, when loaded from the memory device 1104 and executed using the controller(s) 1102, cause the controller(s) 1102 to perform the functions that are described herein.

The computing system 1100 can include many types of memory, data storage, or computer-readable media, such as data storage for program instructions for execution by the controller or any suitable processor. The same or separate storage can be used for images or data, a removable memory can be available for sharing information with other devices, and any number of communication approaches can be available for sharing with other devices. In addition, as shown, the computing system 1100 includes the display 130, which may be a touch screen, organic light emitting diode (OLED), or liquid crystal display (LCD), although devices might convey information via other means, such as through audio speakers, projectors, or casting the display or streaming data to another device, such as a mobile phone, wherein an application on the mobile phone displays the data.

The computing system 1100 also includes the energy storage device 150, which is operable to be recharged through conventional plug-in approaches. In some embodiments, the computing system 1100 can also include at least one additional I/O device 1110 able to receive conventional input from a user. This conventional input can include, for example, a push button, touch pad, touch screen, wheel, joystick, keyboard, mouse, keypad, or any other such device or element whereby a user can input a command to the computing system 1100. In some embodiments, the I/O device(s) 1110 can be connected by a wireless infrared or Bluetooth or other link as well in some embodiments. In some embodiments, the computing system 1100 can include a microphone or other audio capture element that accepts voice or other audio commands. In some embodiments, the I/O device(s) 1110 can include one or more electrodes, optical sensors, barometric sensors (e.g., altimeter, etc.), and the like.

The computing system 1100 can include one or more wireless networking components 1112 operable to communicate with one or more electronic devices within a communication range of a particular wireless channel. The wireless channel can be any appropriate channel used to enable devices to communicate wirelessly, such as Bluetooth, cellular, NFC, Ultra-Wideband (UWB), or Wi-Fi channels. It should be understood that the computing system 1100 can have one or more conventional wired communications connections as known in the art.

The computing system 1100 can include a driver 1114 and at least some combination of one or more emitters 1116 and one or more detectors 1118 for measuring data for one or more metrics of a human body, such as for a person wearing the wearable computing device 100. In some embodiments, for example, this may involve at least one imaging element, such as one or more cameras that are able to capture images of the surrounding environment and that are able to image a user, people, or objects in the vicinity of the device. The image capture element can include any appropriate technology, such as a CCD image capture element having a sufficient resolution, focal range, and viewable area to capture an image of the user when the user is operating the device. Further image capture elements may also include depth sensors. Methods for capturing images using a camera element with a computing device are well known in the art and will not be discussed herein in detail. It should be understood that image capture can be performed using a single image, multiple images, periodic imaging, continuous image capturing, image streaming, etc. Further, the computing system 1100 can include the ability to start and/or stop image capture, such as when receiving a command from a user, application, or other device.

The emitters 1116 and the detectors 1118 may also be capable of being used, in one example, for obtaining optical photoplethysmogram (PPG) measurements. Some PPG technologies rely on detecting light at a single spatial location, or adding signals taken from two or more spatial locations. Both of these approaches result in a single spatial measurement from which the heart rate (HR) estimate (or other physiological metrics) can be determined. In some embodiments, a PPG device employs a single light source coupled to a single detector (i.e., a single light path). Alternatively, a PPG device may employ multiple light sources coupled to a single detector or multiple detectors (i.e., two or more light paths). In other embodiments, a PPG device employs multiple detectors coupled to a single light source or multiple light sources (i.e., two or more light paths). In some cases, the light source(s) may be configured to emit one or more of green, red, infrared (IR) light, as well as any other suitable wavelengths in the spectrum (such as long IR for metabolic monitoring). For example, a PPG device may employ a single light source and two or more light detectors each configured to detect a specific wavelength or wavelength range. In some cases, each detector is configured to detect a different wavelength or wavelength range from one another. In other cases, two or more detectors are configured to detect the same wavelength or wavelength range. In yet another case, one or more detectors configured to detect a specific wavelength or wavelength range different from one or more other detectors). In embodiments employing multiple light paths, the PPG device may determine an average of the signals resulting from the multiple light paths before determining an HR estimate or other physiological metrics.

Moreover, in an embodiment, the emitters 1116 and detectors 1118 may be coupled to the controller 1102 directly or indirectly using driver circuitry by which the controller 1102 may drive the emitters 1116 and obtain signals from the detectors 1118. The host computer 1122 can communicate with the wireless networking components 1112 via the one or more networks 1120, which may include one or more local area networks, wide area networks, UWB, and/or internetworks using any of terrestrial or satellite links. In some embodiments, the host computer 1122 executes control programs and/or application.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A wearable computing device comprising:
a housing;
an energy storage device;
a power interface configured to deliver electrical power from the energy storage device to a circuit included on a band that is removably coupled to the housing;
a switching device configured to selectively couple the energy storage device to the power interface; and
a processor configured to:
control operation of the switching device to couple the energy storage device to the power interface to deliver the electrical power to the circuit included on the band;
obtain data from the circuit on the band that is indicative of a unique identifier for the band; and
control operation of the wearable computing device based, at least in part, on the data indicative of the unique identifier for the band.

2. The wearable computing device of claim 1, wherein the power interface includes a first conductor for power and a second conductor for electrical ground.

3. The wearable computing device of claim 2, wherein the processor is configured to obtain the data indicative of the unique identifier via the first conductor of the power interface.

4. The wearable computing device of claim 1, wherein:
the wearable computing device includes one or more sensors; and
the processor is further configured to determine whether the wearable computing device is being worn by a user based, at least in part, on the data from the one or more sensors.

5. The wearable computing device of claim 4, wherein the one or more sensors include a heart rate sensor and the data includes heart rate data.

6. The wearable computing device of claim 4, wherein the processor is configured to control operation of the switching device to electrically couple the energy storage device to the power interface in response to determining the wearable computing device is not being worn by the user.

7. The wearable computing device of claim 1, wherein the processor is further configured to:
in response to obtaining the data indicative of the unique identifier for the band, control operation of the switching device to decouple the energy storage device from the power interface to cease delivery of the electrical power to the circuit included on the band.

8. The wearable computing device of claim 1, wherein the unique identifier identifies one or more features of the band.

9. The wearable computing device of claim 8, wherein the one or more features include at least one of a material of the band or a color of the band.

10. The wearable computing device of claim 8, wherein the unique identifier is indicative of one or more sensors included on the band.

11. The wearable computing device of claim 10, wherein:
to control operation of the wearable computing device, the processor is configured to obtain data from the one or more sensors on the band.

12. The wearable computing device of claim 11, wherein the processor is configured to obtain the data from the one or more sensors on the band via the power interface.

13. A method for identifying a band coupled to a housing of a wearable computing device, the method comprising:
controlling, via a processor of the wearable computing device, a switching device of the wearable computing device to electrically couple an energy storage device of the wearable computing device to a power interface of the wearable computing device to transfer electrical power from the energy storage device to a circuit included on the band coupled to the housing of the wearable computing device;
obtaining, via the processor, data indicative of a unique identifier for the band from the circuit on the band; and
controlling, via the processor, operation of the wearable computing device based, at least in part, on the unique identifier for the band.

14. The method of claim 13, further comprising:
determining, via a processor of the wearable computing device, the wearable computing device is not being worn by a user; and
controlling the switching device of the wearable computing device to electrically couple the energy storage device of the wearable computing device to the power interface of the wearable computing device to transfer electrical power from the energy storage device to the circuit included on the band coupled to the housing of the wearable computing device occurs in response to determining the wearable computing device is not being worn by the user.

15. The method of claim 14, wherein determining the wearable computing device is not being worn by the user includes:
obtaining data from one or more sensors of the wearable computing device; and
determining the band is coupled to the housing of the wearable computing device based, at least in part, on the data from the one or more sensors.

16. The method of claim 15, wherein the one or more sensors include a heart rate sensor or a motion sensor.

17. The method of claim 13, wherein obtaining the unique identifier for the band includes obtaining, via the processor, the unique identifier from the circuit on the band via the power interface.

18. The method of claim 13, further comprising:
in response to obtaining the data indicative of the unique identifier for the band, controlling operation of the switching device to electrically decouple the energy storage device from the power interface to cease transfer of electrical power from the energy storage device to the circuit included on the band.

19. The method of claim 13, wherein controlling operation of the wearable computing device includes controlling, via the processor, operation of an electronic output device of the wearable computing device.

20. The method of claim 19, wherein:
the electronic output device include a display screen;
the unique identifier indicates a color of the band; and
controlling operation of the display screen includes adjusting a color of at least a portion of the display screen based, at least in part, on the color of the band.
